(19) United States
(12) Patent Application Publication
(10) Pub. No.: US 2022/0051173 A1
(43) Pub. Date: Feb. 17, 2022

(54) RESOURCE SHARING ASSISTING SYSTEM, AND RESOURCE SHARING ASSISTING METHOD

(71) Applicant: Hitachi, Ltd., Tokyo (JP)

(72) Inventors: Haruhisa ISHIDA, Tokyo (JP); Kazuya UYAMA, Tokyo (JP); Tadayoshi KOSAKA, Tokyo (JP)

(21) Appl. No.: 17/431,442

(22) PCT Filed: Oct. 15, 2020
(86) PCT No.: PCT/JP2020/038919

§ 371 Date: Aug. 17, 2021

(30) Foreign Application Priority Data
Nov. 1, 2019 (JP) 2019-199653

(51) Int. Cl. G06Q 10/08

(52) U.S. Cl. CPC G06Q 10/083

(57) ABSTRACT

An inter-transporter similarity calculating section acquires matching histories from a matching history section, and calculates an inter-transporter similarity of each transporter pair. A transporters' perspective evaluation value calculating section acquires matching histories from the matching history section, and uses inter-transporter similarities to calculate a transporters' perspective evaluation value of each shipper as seen from transporters. A matching processing section associates transportation requests, and available resources, and uses the shippers' perspective evaluation values, and the transporters' perspective evaluation values to perform a matching process, and determine a matching result.

### TECHNICAL FIELD

The present invention relates to a resource sharing assisting system, and a resource sharing assisting method for logistics.

### BACKGROUND ART

In recent years, due to an increase of use of home delivery services as a result of the development of the EC market, a shortage of transportation trucks, and drivers in the logistics field is becoming severer. On the other hand, the load factors of trucks are decreasing due to the size reduction of transported articles, and the higher frequency of transportation. In addition, in regions where an improvement in road networks is needed, traffic jams occur often due to an increase of truck transportation, and the environment worsens. Accordingly, there is a need for collaborative deliveries.

As the basic function of logistics, a transporter carries a transported article from a geographical point to another location on the basis of a request of a shipper. However, if nothing is done after the transported article is carried, the transporter has to return with its truck in an empty state, and this is inefficient in terms of use efficiency of logistics resources. Although if the transporter could receive a transportation request about another transported article on its way back, the logistics resource can be used efficiently, it is difficult for a shipper or the transporter to prepare or search for a transported article for the transporter to carry on its way back, and so on. Accordingly, there is a demand for making it possible to associate an available logistics resource on its way back and so on, and a request to make a transported article carried.

Such association has conventional been performed manually by business entities called “mizuya.” In contrast to this, there is an attempt to perform the association by means of a system, along with the development of information processing technology having been achieved in recent years.

Patent Literature 1 proposes a method in which transportation requests/available resources registered on a system are put up for auction online, and matching transportation requests/available resources are determined.

In addition, Patent Literature 2 proposes a method in which transportation plans are optimized across a plurality of enterprises, by using information about available resources of a plurality of transporters, and transportation requests of a plurality of shippers.

### CITATION LIST

### Patent Literatures

Patent Literature 1: Japanese Unexamined Patent Application Publication No. 2001-273417

Patent Literature 2: Japanese Unexamined Patent Application Publication No. 2002-183265

### SUMMARY OF INVENTION

### Technical Problem

In a case that a shipper makes a request to a transporter for transportation of a transported article, it is important whether or not the shipper can be sure of the transporter in terms of the following two perspectives. First, whether or not the transporter is a trustable company. Second, whether the transporter has a sufficient skill necessary for surely carrying the transported article.

Regarding the first perspective, what is concerned with includes whether the transporter transports the transported article without cancellation immediately before processing the request, and so on.

Regarding the first perspective, what is concerned with includes whether skills that are required in accordance with articles to be carried, and locations are known. For example, if articles to be carried are groceries, what is concerned with is whether or not the transporter is capable of temperature management that depends on the articles to be carried, such as drying, chilling or freezing. If an article to be carried is a precision machine, what is concerned with is whether or not the transporter can carry it without causing a rapid acceleration. In addition, depending on warehouses at a departure location, and an arrival location, it matters whether the transporter is capable of required lifting, and lowering work. In addition, if a delivery is requested, what matters is whether the transporter is familiar with road conditions of related locations.

In Patent Literature 1, such information related to bidder transporters is not included, and so a shipper needs to make determinations in terms of the two perspectives described above about the bidder transporters by itself. This is cumbersome work for the shipper, and can be a factor that causes hesitation in using the matching platform.

Patent Literature 2 realizes prioritized determinations of favorably evaluated shippers/transporters as matching shippers/transporters, by asking platform-participant shippers, and transporters to conduct evaluations of results of transportations that are requested/processed as to whether they are good/bad. However, this method does not take differences between shippers, and differences between transported articles into consideration. Accordingly, it is difficult to decide, on the basis of results of evaluation provided by the method of Patent Literature 2, whether or not a transporter can carry a transported article about which a shipper is making a request for transportation.

In this manner, according to the methods of Patent Literatures 1, and 2, there is a problem that a shipper has to make a determination by itself as to whether or not there will be no problems even if the shipper makes a request to a transporter with whom the shipper has not made transactions in the past.

An object of the present invention is to provide a resource sharing assisting system, and a resource sharing assisting method that can solve problems that occur when a shipper makes a request to a transporter with whom the shipper has not made transactions in the past.

### Solution to Problem

A resource sharing assisting system according to one aspect of the present invention is a resource sharing assisting system including a matching history section, an inter-shipper similarity calculating section, a shippers' perspective evaluation value calculating section, an inter-transporter similarity calculating section, a transporters' perspective evaluation value calculating section, and a matching processing section, in which the matching history section stores a matching history, the inter-shipper similarity calculating section acquires the matching history from the matching history section, and calculates an inter-shipper similarity between each shipper pair, the shippers' perspective evaluation value calculating section acquires the matching history from the matching history section, and uses the inter-shipper similarity to calculate a shippers' perspective evaluation value of each transporter as seen from shippers' perspectives, the inter-transporter similarity calculating section acquires the matching history from the matching history section, and calculates an inter-transporter similarity between each transporter pair, the transporters' perspective evaluation value calculating section acquires the matching history from the matching history section, and uses the inter-transporter similarity to calculate a transporters' perspective evaluation value of each shipper as seen from transporters, and the matching processing section associates a transportation request, and an available resource, and uses the shippers' perspective evaluation value, and the transporters' perspective evaluation value to perform a matching process, and determine a matching result.

A resource sharing assisting method according to one aspect of the present invention is a resource sharing assisting method including: a step of acquiring a matching history, and calculating an inter-shipper similarity between each shipper pair, a step of acquiring the matching history, and using the inter-shipper similarity to calculate a shippers' perspective evaluation value of each transporter as seen from shippers' perspectives, a step of acquiring the matching history, and calculating an inter-transporter similarity between each transporter pair, a step of acquiring the matching history, and using the inter-transporter similarity to calculate a transporters' perspective evaluation value of each shipper as seen from transporters, and a step of associating a transportation request, and an available resource, and using the shippers' perspective evaluation value, and the transporters' perspective evaluation value to perform a matching process, and determine a matching result.

### Advantageous Effects of Invention

According to one aspect of the present invention, it is possible to solve problems that occur when a shipper makes a request to a transporter with whom the shipper has not made transactions in the past.

### BRIEF DESCRIPTION OF DRAWINGS

FIG. 1 is a figure depicting a data format of transportation requests.

FIG. 2 is a figure depicting a data format of available resources.

FIG. 3 is a figure depicting a logical system configuration of a resource sharing assisting system for logistics according to an embodiment.

FIG. 4 is a figure depicting a data format of matching histories.

FIG. 5 is a figure depicting a data format of shippers' perspective evaluations.

FIG. 6 is a figure depicting a data format of transporters' perspective evaluations.

FIG. 7 is a figure depicting a data format of inter-shipper similarities.

FIG. 8 is a figure depicting a data format of inter-transporter similarities.

FIG. 9 is an activity diagram of an inter-shipper similarity calculation.

FIG. 10 is an activity diagram of an inter-transporter similarity calculation.

FIG. 11 is an activity diagram of a shippers' perspective evaluation value calculation.

FIG. 12 is an activity diagram of a transporters' perspective evaluation value calculation.

FIG. 13 is an activity diagram of a matching process.

### DESCRIPTION OF EMBODIMENTS

Hereinafter, an embodiment is explained by using the figures.

### Embodiment

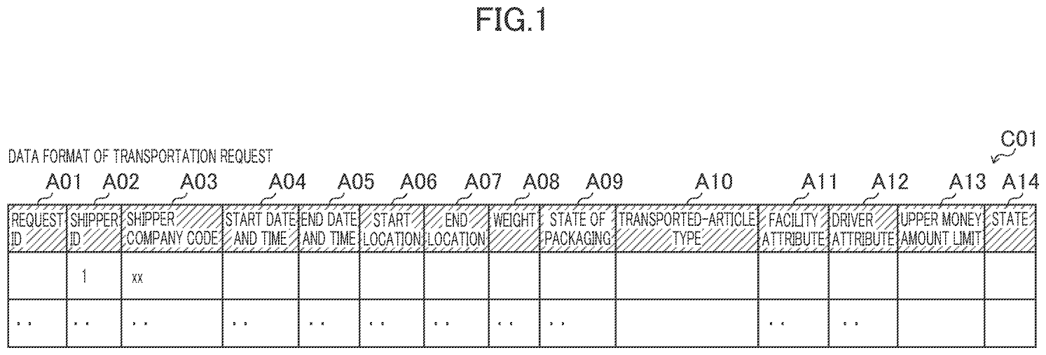

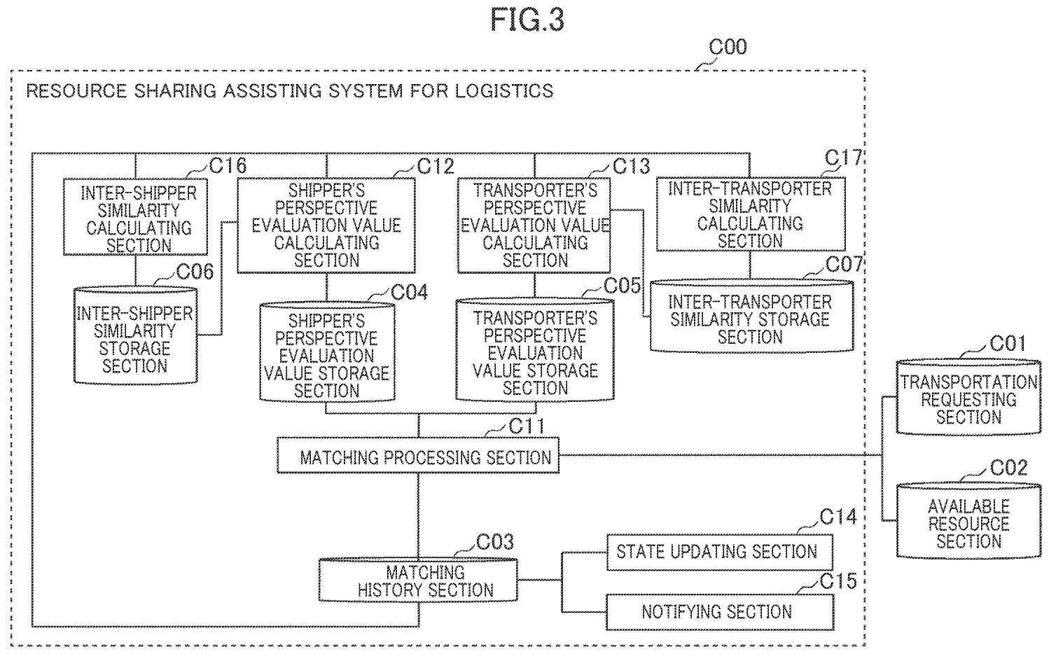

FIG. 1 depicts an example of a format of data retained by a transportation requesting section C01 (see FIG. 3) in an embodiment. Data of a transportation requesting section C02 is represented by a list of sets each including a request ID A01, a shipper ID A02, a shipper company code A03, a start date and time A04, an end date and time A05, a start location A06, an end location A07, a weight A08, a state of packaging A09, a transported-article type A01, a facility attribute A11, a driver attribute Al2, an upper money amount limit A13, and a state A14.

Here, the request ID A01 is an identifier of each line of a transportation request. The shipper ID A02 is an identifier that is determined uniquely in accordance with a shipper who has made the transportation request. The shipper company code A03 is a classification code representing a business category of the shipper, and is represented as a classification code in accordance with classifications according to the TSR business category code book, for example.

The start date and time A04 is a date and time when the relevant request should be started. The end date and time A05 is a date and time when the relevant request should be completed. The start location A06 is a location code representing the start point where transportation of a transported article should be started in accordance with the relevant request. The end location A07 is a location code representing the end point where the transportation of the transported article should be completed in accordance with the relevant request, and this is represented by an address, a latitude and longitude, a delivery center name, or the like.

The weight A08 is a numerical value representing the weight of the transported article related to the relevant request. The state of packaging A09 is a set of numerical values representing the shape of the transported article related to the relevant request, and is represented by a set of three lengths representing vertical, horizontal, and depth dimensions representing the external shape of the article to be transported, or the like. The transported-article type A10 is a classification code or a string representing the type of the transported article related to the relevant request, and is represented by a string like groceries or precision mechanical equipment, or a classification code such as an HS Code, for example.

The facility attribute A11 is a list of strings representing features that a facility to be used when the relevant request is processed should have, and is represented by a list of strings like a refrigerator vehicle, and a wing vehicle, for example. The driver attribute A12 is a list of strings representing capabilities that a person in charge of the relevant request should have, and is represented by a list of strings like a license for operating a forklift, and the like, for example. The upper money amount limit A13 is a numerical value representing the upper limit of an amount of money that the shipper can pay for processing of the relevant request. The state A14 is a value representing whether or not the transportation request has a matching available resource in accordance with the present system, or whether or not the transportation request is a processing target, and is represented by an enum (enumerated type) value represented by a value such as unallocated, allocated, or cancelled, for example. Each piece of data included in the transportation requesting section C01 is created by a shipper who wants an article to be transported inputting those pieces of information. In addition, some attributes may be measured automatically, or may be input by interpolation based on past input histories.

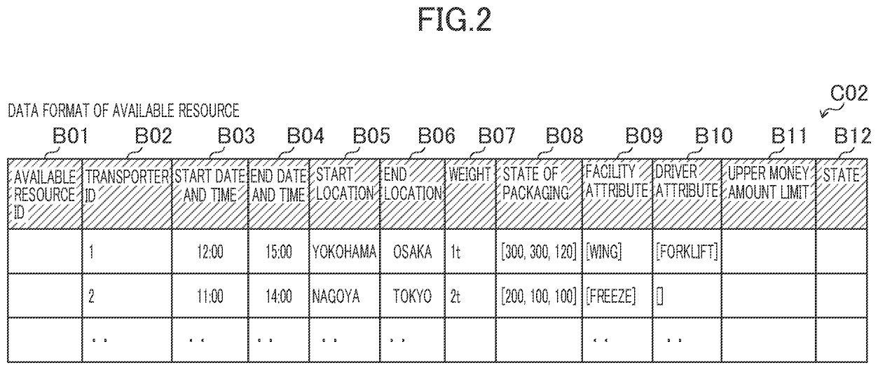

FIG. 2 depicts an example of a format of data retained by an available resource section C02 (see FIG. 3) in the embodiment. Data of the available resource section C02 is represented by a list of sets each including an available resource ID B01, a transporter ID B02, a start date and time B03, an end date and time B04, a start location B05, an end location B06, a weight B07, a state of packaging B08, a facility attribute B09, a driver attribute B10, a lower money amount limit B11, and a state B12.

Here, the available resource ID B01 is an identifier of each line of an available resource.

The transporter ID B02 is an identifier that is determined uniquely in accordance with a transporter who has a transportation resource to which transportation is not allocated currently. The start date and time B03 is a date and time when the relevant resource becomes available. The end date and time B04 is a date and time when use of the relevant resource should be completed. The start location B05 is a location code representing a start point in a case the relevant resource is to be used. The end location B06 is a location code representing an end point in the case that the relevant resource is to be used.

The weight B07 is a numerical value representing an upper limit weight of a transported article that the relevant resource can transport. The state of packaging B08 is a set of numerical values representing the upper limit size of a transported article that the relevant resource can transport. The facility attribute B09 is a list of strings representing features of the relevant resource. The driver attribute B10 is a list of strings representing capabilities of a person to be responsible for the transportation in a case that the relevant resource is to be used. The lower money amount limit B11 is a numerical value representing a minimum amount of money of a consideration that the transporter wants to receive in a case that a transportation request is processed by using the relevant available resource. The state B11 is a value representing whether or not the available resource has a matching transportation request in accordance with the present system, or whether or not the transportation request is a processing target, and is represented by an enum value represented by a value such as unallocated, allocated, or cancelled, for example.

Each piece of data included in the available resource C02 is created by a transporter having an available resource inputting those pieces of information. In addition, some attributes may be measured automatically, or may be input by interpolation based on past input histories.

FIG. 3 is a figure depicting a logical system configuration of a resource sharing assisting system for logistics according to an embodiment.

A resource sharing assisting system C00 includes a matching history section C03, a shippers' perspective evaluation value storage section C04, a transporters' perspective evaluation value storage section C05, an inter-shipper similarity storage section C06, an inter-transporter similarity storage section C07, a matching processing section C11, a shippers' perspective evaluation value calculating section C12, a transporters' perspective evaluation value calculating section C13, a state updating section C14, a notifying section C15, an inter-shipper similarity calculating section C16, and an inter-transporter similarity calculating section C17.

The matching processing section C11 associates a transportation request, and an available resource that are acquired from the transportation requesting section C01 described with reference to FIG. 1, and the available resource section C02 described with reference to FIG. 2. At this time, data acquired from the shippers' perspective evaluation value storage section C04, and the transporters' perspective evaluation value storage section C05 are used to determine matching evaluation values, and the matching evaluation values are reflected in a matching result. In addition, the states of entries in the transportation requesting section C01, and the available resource section C02 that are determined as matching entries in accordance with a processing result are updated.

The shippers' perspective evaluation value calculating section C12 acquires matching histories from the matching history section C03, calculates an evaluation value of each transporter as seen from shippers' perspectives, and stores the evaluation values on the shippers' perspective evaluation value storage section C04. At this time, inter-shipper similarities stored on the inter-shipper similarity storage section C06 are used.

The transporters' perspective evaluation value calculating section C13 acquires matching histories from the matching history section C03, calculates an evaluation value of each shipper as seen from transporters' perspectives, and stores the evaluation values on the transporters' perspective evaluation value storage section C05. At this time, inter-transporter similarities stored on the inter-transporter similarity storage section C07 are used.

The state updating section C14 acquires, and updates the state of each entry included in the matching history section C03 as to whether transportation corresponding to the entry was processed normally, or cancelled for a reason attributable to a shipper/transporter, and stores, on the matching history section C03, an evaluation value reflecting an evaluation value obtained from the shipper/transporter after completion of the transportation.

When a matching result is stored on the matching history section C03, the notifying section C15 notifies the shipper and the transporter of the matching result.

The inter-shipper similarity calculating section C16 acquires matching histories from the matching history section C03, calculates a similarity between each shipper pair, and stores the similarity on the inter-shipper similarity storage section C06.

The inter-transporter similarity calculating section C17 acquires matching histories from the matching history section C03, calculates a similarity between each transporter pair, and stores the similarity on the inter-transporter similarity storage section C07.

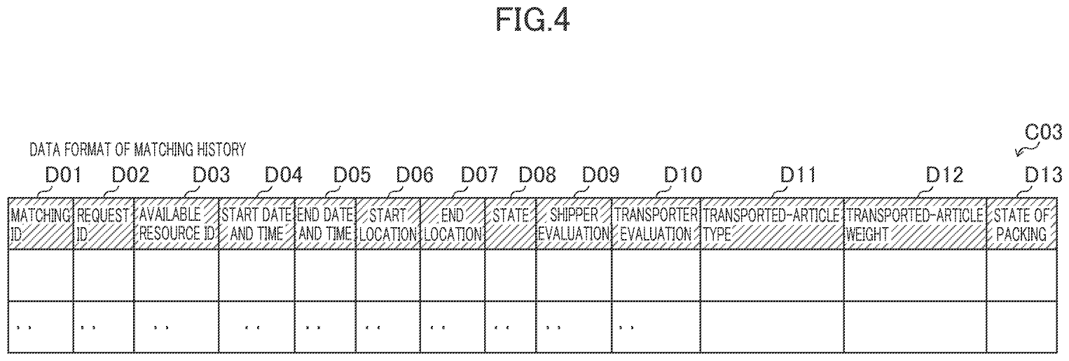

FIG. 4 depicts an example of a format of data retained by the matching history section C03 in the embodiment. Data of the matching history section C03 is represented by a list of sets each including a matching ID D01, a request ID D02, an available resource ID D03, a start date and time D04, an end date and time D05, a start location D06, an end location D07, a state D08, a shipper evaluation result D09, a transporter D10, a transported-article type D11, a transported-article weight D12, and a state of packaging D13.

Here, the matching ID D01 is an identifier of each line of a matching history.

The request ID D02, and the available resource ID D03 are identifiers of entries corresponding to a matching transportation request C01, and available resource C02. The start date and time D04 represents a start date and time when transportation should be started by the available resource that is associated as a result of the matching. The end date and time D05 represents a date and time when it should be completed.

The start location D06 is a code representing a location where transportation should be started by the available resource that is associated as a result of the matching, and the end location is a code representing a location where it should be completed. The state D08 is a value representing the state of the matching, and is represented by an enum value including a value such as before being performed, currently being performed, normally completed, abnormally ended, cancelled for a reason attributable to the shipper, or cancelled for a reason attributable to the transporter, for example. The shipper evaluation result D09 is a value representing an evaluation value of evaluation by the shipper after the transportation according to the matching result is performed, and is represented by a numerical value selected from consecutive values from 0 to 10, for example.

The transporter evaluation result D10 is a value representing an evaluation value of evaluation by the transporter after the transportation according to the matching result is performed, and is represented by a numerical value selected from consecutive values from 0 to 10, for example. The transported-article type D11 is a classification code or a string representing the type of the transported article that is carried in accordance with the matching result, and is represented by a string like groceries or precision mechanical equipment, or a classification code such as an HS Code, for example. The transported-article weight D12 is a numerical value representing the weight of the transported article carried in accordance with the matching result. The state of packaging D13 is a set of numerical values representing the shape of the transported article carried in accordance with the matching result, and is represented by a set of three lengths representing vertical, horizontal, and depth dimensions representing the external shape of the article to be transported, or the like.

FIG. 5 depicts an example of a format of data retained by the shippers' perspective evaluation value storage section C04 in the embodiment.

Data of a shippers' perspective evaluation C04 is represented by a list of sets each including a shipper ID E01, a transporter ID E02, and an evaluation value E03. Here, the shipper ID E01 is an identifier representing a shipper who is using the present system. The transporter ID E02 is an identifier representing a transporter who is using the present system. The evaluation value E03 represents an evaluation value that is obtained when the shipper corresponding to the identifier of the shipper ID E01 stored in the relevant line evaluates the transporter corresponding to the identifier of the transporter ID E02, and is represented by a numerical value selected from consecutive values from 0 to 10, for example.

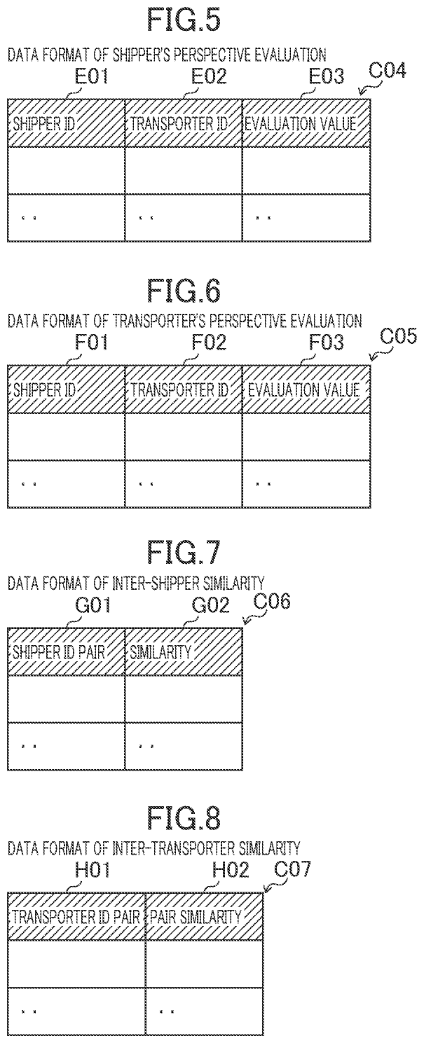

FIG. 6 depicts an example of a format of data retained by the transporters' perspective evaluation value storage section C05 in the embodiment.

Data of a transporters' perspective evaluation value storage section C05 is represented by a list of sets each including a shipper ID F01, a transporter ID F02, and an evaluation value F03. Here, the shipper ID F01 is an identifier representing a shipper who is using the present system. The transporter ID F02 is an identifier representing a transporter who is using the present system. The evaluation value F03 represents an evaluation value that is obtained when the transporter corresponding to the identifier of the transporter ID F02 stored in the relevant line evaluates the shipper corresponding to the identifier of the shipper ID F01, and is represented by a numerical value selected from consecutive values from 0 to 10, for example.

FIG. 7 depicts an example of a format of data retained by the inter-shipper similarity storage section C06 in the embodiment.

Data of an inter-shipper similarity C06 is represented by a list of sets each including a shipper ID pair G01, and a similarity G02. Here, the shipper ID pair G01 is a set of two different shipper IDs, and the similarity G02 is represented by a numerical value.

FIG. 8 depicts an example of a format of data retained by the inter-transporter similarity storage section C07 in the embodiment.

Data of the inter-transporter similarity storage section C07 is represented by a list of sets each including a transporter ID pair H01, and a similarity H02. Here, the transporter pair H01 is a set of two different transporter IDs, and the similarity H02 is represented by a numerical value.

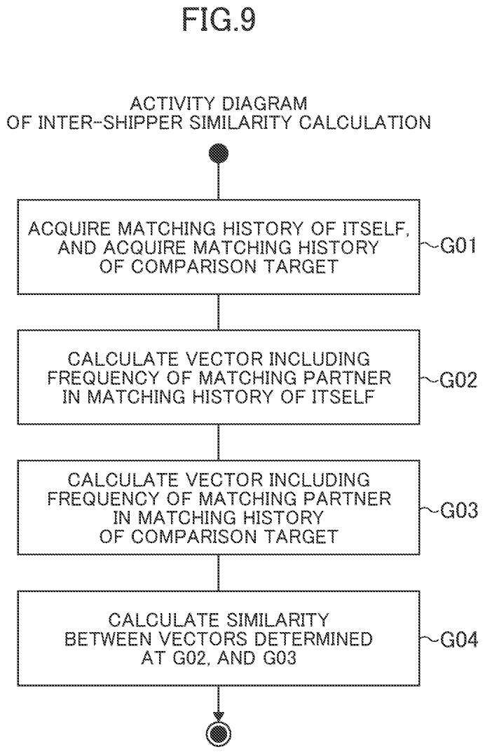

FIG. 9 is an activity diagram depicting a process of the inter-shipper similarity calculating section C16. FIG. 9 depicts a separate similarity calculation to be performed when a similarity between each shipper pair who uses the present system is calculated.

At Step G01, normally completed past matching histories of a shipper, and normally completed past matching histories of a comparison target shipper are acquired. As a method for the acquisition, those matching histories are acquired by using IDs of the shippers as a search condition, and by using a certain past period, or a certain number of past cases as an acquisition condition.

At Step G02, the frequency of each matching partner in the past matching histories of the shipper acquired at Step G01 is calculated, and a vector value including the values is computed. In addition, at that time, the vector is normalized such that the norm value becomes 1.

At Step G03, the frequency of each matching partner in the past matching histories of the comparison target shipper acquired at Step G01 is calculated, and a vector value including the values is computed. In addition, at that time, the vector is normalized such that the norm value becomes 1.

At Step G04, the inner product of the vectors determined at Steps G02, and G03 is determined, and the value is determined as the similarity between the shipper, and the comparison target shipper. The value is stored on the inter-shipper similarity storage section C06 in association with a pair of the ID of the shipper, and the ID of the comparison target shipper.

Note that in a case that there are not sufficient accumulated matching histories, it is also possible to use a classification code representing the business category of the shipper at the time of the similarity computation. In one possible method, the similarity is computed by mapping the matching degrees of classification codes to preset numerical values, and so on. For example, in a case that the shippers match in terms of small classifications, the similarity is 0.9, in a case that the shippers match in terms of medium classifications, the similarity is 0.6, in a case that the shippers match in terms of large classifications, the similarity is 0.3, and in a case that the shippers do not match in terms of none of the classifications, the similarity is 0.1.

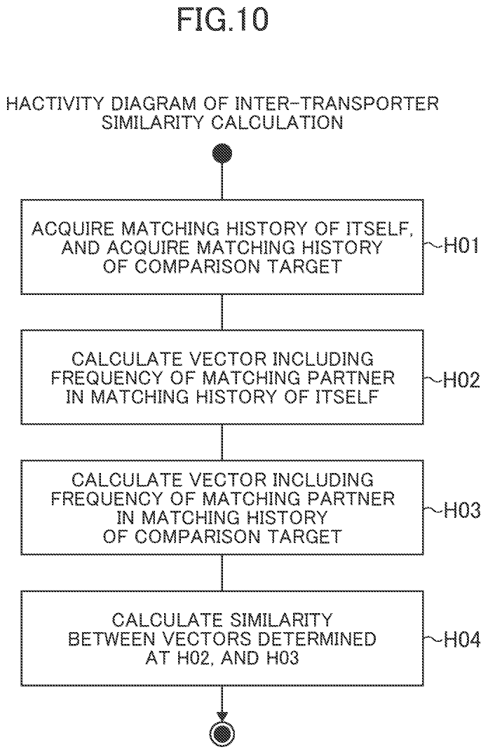

FIG. 10 is an activity diagram depicting a process of the inter-transporter similarity calculating section C17. FIG. 10 depicts a separate similarity calculation to be performed when a similarity between each transporter pair who uses the present system is calculated.

At Step H01, normally completed past matching histories of a transporter, and normally completed past matching histories of a comparison target transporter are acquired. As a method for the acquisition, those matching histories are acquired by using IDs of the transporters as a search condition, and by using a certain past period, or a certain number of past cases as an acquisition condition.

At Step H02, the frequency of each matching partner in the past matching histories of the transporter acquired at Step H01 is calculated, and a vector value including the values is computed. In addition, at that time, the vector is normalized such that the norm value becomes 1.

At Step H03, the frequency of each matching partner in the past matching histories of the comparison target transporter acquired at Step H01 is calculated, and a vector value including the values is computed. In addition, at that time, the vector is normalized such that the norm value becomes 1.

At Step H04, the inner product of the vectors determined at Steps H02, and H03 is determined, and the value is determined as the similarity between the transporter, and the comparison target transporter. The value is stored on the inter-transporter similarity storage section C07 in association with a pair of the ID of the transporter, and the ID of the comparison target transporter.

Note that in a case that there are not sufficient accumulated matching histories, vectors are determined at Step H02, and Step H03 assuming that the transporters have made transactions with all the shippers at the same frequency, and the vectors are used for the similarity computation at Step H04.

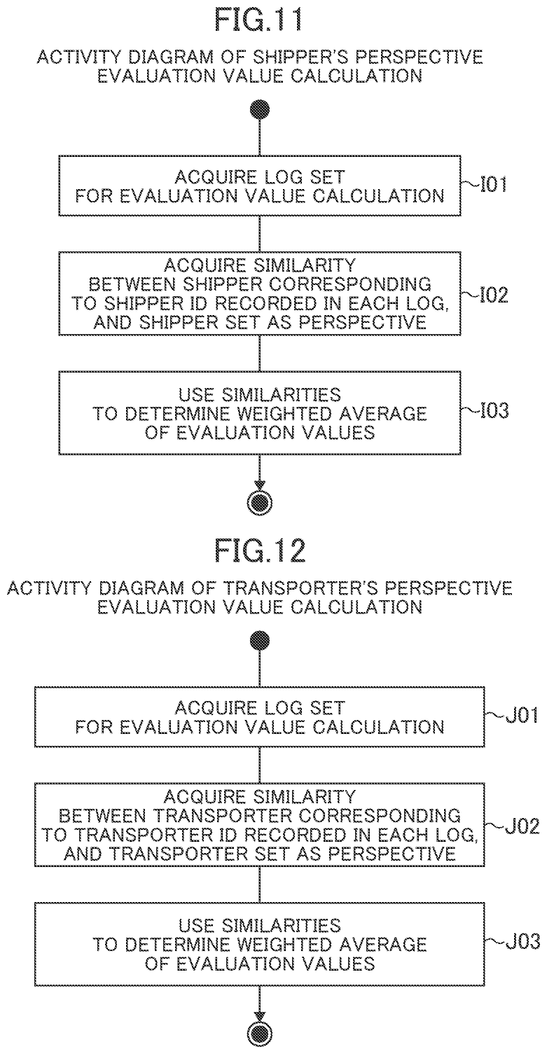

FIG. 11 is an activity diagram representing a process of the shippers' perspective evaluation value calculating section C12. FIG. 11 depicts a process to be performed for each shipper who uses the present system when an evaluation value as seen from the shipper (defined as a shipper A) of a transporter (defined as a transporter A) is determined when an evaluation value of each transporter who uses the present system is calculated.

At Step I01, past matching histories to be used for the evaluation value calculation are acquired from the matching history section C03. As a method for the acquisition, entries in the matching history section C03 that include the ID of the transporter A are acquired by using a certain past period from the current time, or a certain number of past cases as an acquisition condition. In addition, at this time, acquisition of entries including the ID of the shipper A may be prioritized.

At Step I02, a similarity between a shipper who has evaluated each history included in the set of the matching histories acquired at Step I01, and the shipper A is acquired from the inter-shipper similarity storage section C06.

At Step I03, the similarities determined at Step I02 are used to determine the weighted average of the shipper evaluation results included in the matching histories. For example, the weighted average is determined in accordance with the formula, (Σsimilarity×shipper evaluation result)=Σsimilarity).

This process is performed at intervals of a certain length of time, like every day at a fixed time or every other hour. The calculated evaluation value is stored in a relevant entry in the shippers' perspective evaluation value storage section C04, by using the ID of the shipper A, and the ID of the transporter A as keys.

FIG. 12 is an activity diagram representing a process of the transporters' perspective evaluation value calculating section C13. FIG. 12 depicts a process to be performed for each transporter who uses the present system when an evaluation value as seen from the transporter (defined as a transporter A) of a shipper (defined as a shipper A) is determined when an evaluation value of each shipper who uses the present system is calculated.

At Step J01, past matching histories to be used for the evaluation value calculation are acquired from the matching history section C03. As a method for the acquisition, entries in the matching history section C03 that include the ID of the shipper A are acquired by using a certain past period from the current time, or a certain number of past cases as an acquisition condition. In addition, at this time, acquisition of entries including the ID of the transporter A may be prioritized.

At Step J02, a similarity between a transporter who has evaluated each history included in the set of the matching histories acquired at Step J01, and the transporter A is acquired from the inter-transporter similarity storage section C07.

At Step J03, the similarities determined at Step J02 are used to determine the weighted average of the transporter evaluation results included in the matching histories. For example, the weighted average is determined in accordance with the formula, (Σsimilarity×transporter evaluation result)=Σsimilarity).

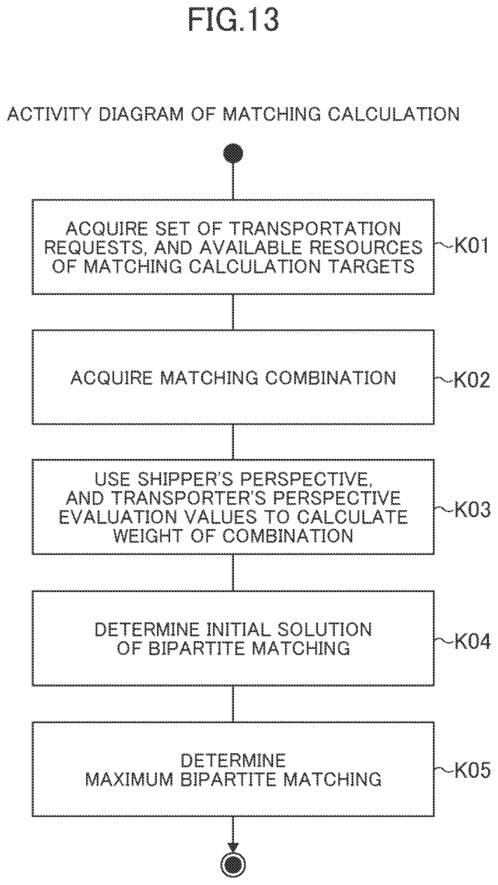

FIG. 13 is an activity diagram depicting a process of the matching processing section C11.

At Step K01, sets of matching calculation target transportation requests, and available resources are acquired from the transportation requesting section C01, and the available resource section C02. As a method for the acquisition, transportation requests, and available resources are acquired by using a time range as a search condition. For example, the start date and time is set to one hour after the current time, the end date and time is set to 49 hours after the current time, and transportation requests, and available resources whose start dates and times, and end dates and times are included in the range are acquired, and so on.

At Step K02, a set of combinations of transportation requests, and available resources that are in the transportation request set, and the available resource set acquired at Step K01, and can be combined are determined. It is determined here whether transportation requests, and available resources can be combined in terms of all of dates and times, locations, weights, states of packaging, facility attributes, driver attributes, amounts of money. If, regarding start dates and times, the start date and time of a transportation request is the same as or after the start date and time of an available resource, regarding end dates and times, the end date and time of the transportation request is the same as or before the end date and time of the available resource, and regarding start locations, and end locations, the distance between the location of the transportation request, and the location of the available resource is equal to or shorter than a certain distance specified in the system, it is determined that the transportation request, and the available resource can be combined.

In addition, if, regarding weights, the weight of the transportation request is equal to or lower than the weight of the available resource, regarding states of packaging, the external shape of the state of packaging of the transportation request is smaller than the external shape of the available resource, regarding facility attributes, the attributes that are required for the transportation request are included in the attributes of the available resource, and, regarding driver attributes, the attributes required for the transportation request are included in the attributes of the available resource, it is determined that the transportation request, and the available resource can be combined. If, regarding amounts of money, the upper money amount limit of the transportation request is higher than the lower money amount limit of the available resource, it is determined that the transportation request, and the available resource can be combined.

At Step K03, about each combination candidate determined at Step K02, evaluation values stored on the shippers' perspective evaluation value storage section C04, and the transporters' perspective evaluation value storage section C05 are used to calculate a weight of the combination. At this time, as a method of the calculation of the weight, the average of the shippers' perspective evaluation value, and the transporters' perspective evaluation value, or the value of a smaller one or larger one of them is used.

At Step K04, an initial solution of combinations is determined. For example, the initial solution is determined by sorting each of the available resource set, and the transportation request set in accordance with start times, and then greedily (greedy method) searching for pairs that can be combined from the first ones in ascending order of time.

At Step K05, the weights determined at Step K03 are used to determine the weighted maximum bipartite matching of available resources, and transportation requests. This can be realized by performing searches until there are no more augmenting paths such that the weight of the whole is maximized.

In the embodiment described above, in a resource sharing system for logistics that determines association between transportation requests of shippers, and available resource information retained by transporters, attribute information about shippers/transporters is used to compute results of evaluation of each shipper/transporter from each shipper/transporter's perspective based on past cases, and a matching result that maximizes weighting at the time of using the results of evaluation as weights is determined.

At this time, tendencies of past matching partners are used to compute inter-shipper, and inter-transporter similarities, the similarities are used to weight past results of evaluation, and the weighted past results of evaluation are used.

In addition, regarding shippers for whom there are not sufficient accumulated matching histories, business category classification codes are used to compute inter-shipper similarities, the similarities are used to weight past evaluation results, and the weighted past evaluation results are used.

In addition, when it is computed whether or not it is possible to associate an available resource and a transportation request, times, locations, weights, states of packaging, transported-article types, facility attributes, driver attributes, and amounts of money are used.

In this manner, in the embodiment described above, regarding possible partners with whom transactions have not been made in the past, results of evaluation of other shippers/transporters are used to evaluate whether there will be no problems if requests are made to those possible partners, and whether they are capable of processing the requests. At that time, similarities between features of business categories of shippers that conducted evaluations in the past, and facilities of transporters, and corresponding features of evaluation target shippers/transporters are determined, and the similarities are used as weights to determine the weighted averages of past evaluations. In addition, the determined evaluation values are used to determine matching ones of requests of a plurality of shippers, and available resources of transporters.

According to the embodiment described above, as compared with a case that past evaluation histories on a platform are used uniformly about possible partners with whom transactions have not been made in the past, client sides can conduct evaluations taking characteristics of themselves and the possible partners into consideration. In addition, matching results taking the affinities of the combinations into consideration can be determined.

### LIST OF REFERENCE SIGNS

C00: Resource sharing assisting system
C01: Transportation requesting section
C02: Resource section
C03: Matching history section
C04: Shippers' perspective evaluation value storage section
C05: Transporters' perspective evaluation value storage section
C06: Inter-shipper similarity storage section C06
C07: Inter-transporter similarity storage section
C07: Matching processing section
C12: Shippers' perspective evaluation value calculating section
C13: Transporters' perspective evaluation value calculating section
C14: State updating section
C15: Notifying section
C16: Inter-shipper similarity calculating section
C17: Inter-transporter similarity calculating section

1. A resource sharing assisting system comprising a matching history section, an inter-shipper similarity calculating section, a shippers' perspective evaluation value calculating section, an inter-transporter similarity calculating section, a transporters' perspective evaluation value calculating section, and a matching processing section, wherein
the matching history section stores a matching history,
the inter-shipper similarity calculating section acquires the matching history from the matching history section, and calculates an inter-shipper similarity between each shipper pair,
the shippers' perspective evaluation value calculating section acquires the matching history from the matching history section, and uses the inter-shipper similarity to calculate a shippers' perspective evaluation value of each transporter as seen from shippers' perspectives,
the inter-transporter similarity calculating section acquires the matching history from the matching history section, and calculates an inter-transporter similarity between each transporter pair,
the transporters' perspective evaluation value calculating section acquires the matching history from the matching history section, and uses the inter-transporter similarity to calculate a transporters' perspective evaluation value of each shipper as seen from transporters, and
the matching processing section associates a transportation request, and an available resource, and uses the shippers' perspective evaluation value, and the transporters' perspective evaluation value to perform a matching process, and determine a matching result.

2. The resource sharing assisting system according to claim 1, further comprising a state updating section that makes the matching result stored on the matching history section reflect the shippers' perspective evaluation value, and the transporters' perspective evaluation value.

3. The resource sharing assisting system according to claim 2, further comprising a notifying section that notifies the matching result to a shipper, and a transporter when the matching result is stored on the matching history section.

4. The resource sharing assisting system according to claim 1, wherein
the inter-shipper similarity calculating section
acquires a matching history of itself, and a matching history of a comparison target,
calculates a first vector including frequency of a matching partner in the matching history of itself,
calculates a second vector including frequency of the matching partner in the matching history of the comparison target, and
uses the first vector, and the second vector to calculate the inter-shipper similarity.

5. The resource sharing assisting system according to claim 1, wherein the inter-shipper similarity calculating section uses a classification code representing a business category of a shipper to calculate the inter-shipper similarity in a case that the matching history is not accumulated in the matching history section.

6. The resource sharing assisting system according to claim 1, wherein
the inter-transporter similarity calculating section
acquires a matching history of itself, and a matching history of a comparison target,
calculates a third vector including frequency of a matching partner in the matching history of itself,
calculates a fourth vector including frequency of the matching partner in the matching history of the comparison target, and
uses the third vector, and the fourth vector to calculate the inter-transporter similarity.

7. The resource sharing assisting system according to claim 1, wherein
the shippers' perspective evaluation value calculating section
acquires the matching history from the matching history section,
for each history included in a set of the acquired matching histories, acquires a first similarity between a shipper that has evaluated the history, and a shipper that is set as a perspective, and
uses the first similarity to determine a weighted average of the shippers' perspective evaluation value.

8. The resource sharing assisting system according to claim 1, wherein
the transporters' perspective evaluation value calculating section
acquires the matching history from the matching history section,
for each history included in a set of the acquired matching histories, acquires a second similarity between a transporter that has evaluated the history, and a transporter that is set as a perspective, and
uses the second similarity to determine a weighted average of the transporters' perspective evaluation value.

9. The resource sharing assisting system according to claim 1, wherein
the matching processing section
acquires a set of the transportation requests, and the available resources,
acquires a matching combination in the acquired set,
uses the shippers' perspective evaluation value, and the transporters' perspective evaluation value to calculate a weight of the acquired combination,
determines an initial solution of bipartite matching, and
performs the matching process by determining maximum bipartite matching.

10. The resource sharing assisting system according to claim 1, wherein
the matching history section stores a shipper evaluation result, and a transporter evaluation result,
the shipper evaluation result is a value representing an evaluation value of evaluation by a shipper after transportation based on the matching result of the matching process has been performed, and
the transporter evaluation result is a value representing an evaluation value of evaluation by a transporter after the transportation based on the matching result is performed.

11. A resource sharing assisting method comprising:
a step of acquiring a matching history, and calculating an inter-shipper similarity between each shipper pair,
a step of acquiring the matching history, and using the inter-shipper similarity to calculate a shippers' perspective evaluation value of each transporter as seen from shippers' perspectives,
a step of acquiring the matching history, and calculating an inter-transporter similarity between each transporter pair,
a step of acquiring the matching history, and using the inter-transporter similarity to calculate a transporters' perspective evaluation value of each shipper as seen from transporters, and
a step of associating a transportation request, and an available resource, and using the shippers' perspective evaluation value, and the transporters' perspective evaluation value to perform a matching process, and determine a matching result.

12. The resource sharing assisting method according to claim 11, wherein
the step of calculating the inter-shipper similarity includes:
acquiring a matching history of itself, and a matching history of a comparison target;
calculating a first vector including frequency of a matching partner in the matching history of itself;
calculating a second vector including frequency of the matching partner in the matching history of the comparison target; and
using the first vector, and the second vector to calculate the inter-shipper similarity.

13. The resource sharing assisting method according to claim 11, wherein
the step of calculating the inter-transporter similarity includes:
acquiring a matching history of itself, and a matching history of a comparison target;
calculating a third vector including frequency of a matching partner in the matching history of itself;
calculating a fourth vector including frequency of the matching partner in the matching history of the comparison target; and
using the third vector, and the fourth vector to calculate the inter-transporter similarity.

14. The resource sharing assisting method according to claim 11, wherein
the step of calculating the shippers' perspective evaluation value includes:
for each history included in a set of the matching histories, acquiring a first similarity between a shipper that has evaluated the history, and a shipper set as a perspective; and
using the first similarity to determine a weighted average of the shippers' perspective evaluation value, and
the step of calculating the transporters' perspective evaluation value includes:
for each history included in a set of the acquired matching histories, acquiring a second similarity between a transporter that has evaluated the history, and a transporter that is set as a perspective, and
using the second similarity to determine a weighted average of the transporters' perspective evaluation value.

15. The resource sharing assisting method according to claim 11, wherein
the step of determining the matching result includes:
acquiring a set of the transportation requests, and the available resources,
acquiring a matching combination in the acquired set, using the shippers' perspective evaluation value, and the transporters' perspective evaluation value to calculate a weight of the acquired combination,
determining an initial solution of bipartite matching, and
performing the matching process by determining maximum bipartite matching.
